(19) United States
(12) Patent Application Publication
(10) Pub. No.: US 2013/0162701 A1
(43) Pub. Date: Jun. 27, 2013

(54) SYSTEM AND A METHOD OF ADAPTIVELY CONTROLLING AN LED BACKLIGHT

(71) Applicants: Sheng Kai Yang, Tainan City (TW); Biing-Seng Wu, Tainan City (TW); KUEI-HSIANG CHEN, Tainan City (TW); Ming-Chih Wang, Tainan City (TW)

(72) Inventors: Sheng Kai Yang, Tainan City (TW); Biing-Seng Wu, Tainan City (TW); KUEI-HSIANG CHEN, Tainan City (TW); Ming-Chih Wang, Tainan City (TW)

(73) Assignee: HIMAX MEDIA SOLUTIONS, INC., Tainan City (TW)

(21) Appl. No.: 13/540,509

(22) Filed: Jul. 2, 2012

Related U.S. Application Data
(60) Provisional application No. 61/580,573, filed on Dec. 27, 2011.

(30) Foreign Application Priority Data
May 23, 2012 (TW) 101118321

(51) Int. Cl. G09G 5/10

(52) U.S. Cl. 345/691; 345/690

(57) ABSTRACT

The present invention is directed to a system and method of adaptively controlling a light-emitting diode (LED) backlight. A content analyzer analyzes luminance of image data to be displayed on a display panel. An LED current controller controls illumination of the LED backlight via an LED driver according to an analysis result of the content analyzer. The LED current controller over-drives the LED backlight such that a drive current flowing in the LED backlight is above a normal current, when the analysis result of the content analyzer indicates that the luminance of image data is above a predetermined value.

### CROSS-REFERENCE TO OTHER APPLICATIONS

The present application claims the benefit of U.S. Provisional Application No. 61/580,573, filed on Dec. 27, 2011 and entitled “LED current control based on image content luminance for power saving” (Att. Docket HI8647PR), and Taiwan Patent Application No. 101118321, filed on May 23, 2012, the entire contents both of which are hereby incorporated by reference.

### BACKGROUND OF THE INVENTION

1. Field of the Invention

The present invention generally relates to a backlight, and more particularly to a system and method of adaptively controlling a light-emitting diode (LED) backlight adaptable to a flat display panel.

2. Description of Related Art

A backlight is commonly used to illuminate a flat display panel, such as a liquid crystal display (LCD) panel, from the back or side of the flat display panel. The light source of the backlight may be cold cathode fluorescent lamp (CCFL), light-emitting diode (LED) or other light sources, among which the LED backlight becomes more popular due to its low power consumption, quick response and long lifetime.

FIG. 1A schematically shows an LED backlight, which is made of plural LED strings that are coupled in parallel. Each LED string is made of plural LEDs that are coupled in series. As shown in FIG. 1B, luminous intensity of the LED is generally in linear proportion to a current forwardly flowing in the LED.

A conventional backlight, such as the LED backlight, typically illuminates with constant luminous intensity. As the content of image data usually does not occupy its fully dynamic range, i.e., from the darkest to the brightest, a dynamic range of the display panel is therefore inefficiently used. Another disadvantage of the conventional backlight, such as the LED backlight, is its low dynamic contrast.

A need has thus arisen to propose a novel LED backlight with enhanced contrast while utilizing the favorable advantages of the LED.

### SUMMARY OF THE INVENTION

In view of the foregoing, it is an object of the embodiment of the present invention to provide a system and method of adaptively controlling a light-emitting diode (LED) backlight in order to substantially enhance dynamic contrast of an image to be displayed, and/or to save considerable energy.

According to one embodiment, the system of adaptively controlling an LED backlight includes a content analyzer, an LED driver and an LED current controller. The content analyzer is configured to analyze luminance of image data to be displayed on a display panel. The LED driver is configured to drive the LED backlight. The LED current controller is configured to control illumination of the LED backlight via the LED driver according to an analysis result of the content analyzer. The LED current controller over-drives the LED backlight such that a drive current flowing in the LED backlight is above a normal current, when the analysis result of the content analyzer indicates that the luminance of image data is above a predetermined value.

### BRIEF DESCRIPTION OF THE DRAWINGS

FIG. 1A schematically shows a conventional light-emitting diode (LED) backlight;

FIG. 1B shows a relationship between luminous intensity and a current flowing in a conventional LED;

FIG. 2 shows a block diagram illustrating a system of adaptively controlling an LED backlight according to a first embodiment of the present invention;

FIG. 3A to FIG. 3C show relationship among a normal dynamic range of the display panel, a dynamic range of image content and a dynamic range of an under-driven display panel;

FIG. 4 shows a block diagram illustrating a partial system of adaptively controlling an LED backlight according to a second embodiment of the present invention;

FIG. 5 shows a block diagram illustrating a system of adaptively controlling an LED backlight according to a third embodiment of the present invention;

FIG. 6A shows a flow diagram illustrating a method of adaptively controlling an LED backlight according to a fourth embodiment of the present invention;

FIG. 6B shows exemplary drive current variation with respect to time in association with FIG. 6A;

FIG. 7A shows a flow diagram illustrating a method of adaptively controlling an LED backlight according to a fifth embodiment of the present invention;

FIG. 7B shows exemplary drive current variation with respect to time in association with FIG. 7A; and

FIG. 7C exemplifies derivation of a duty cycle of a PWM signal by a sampling clock.

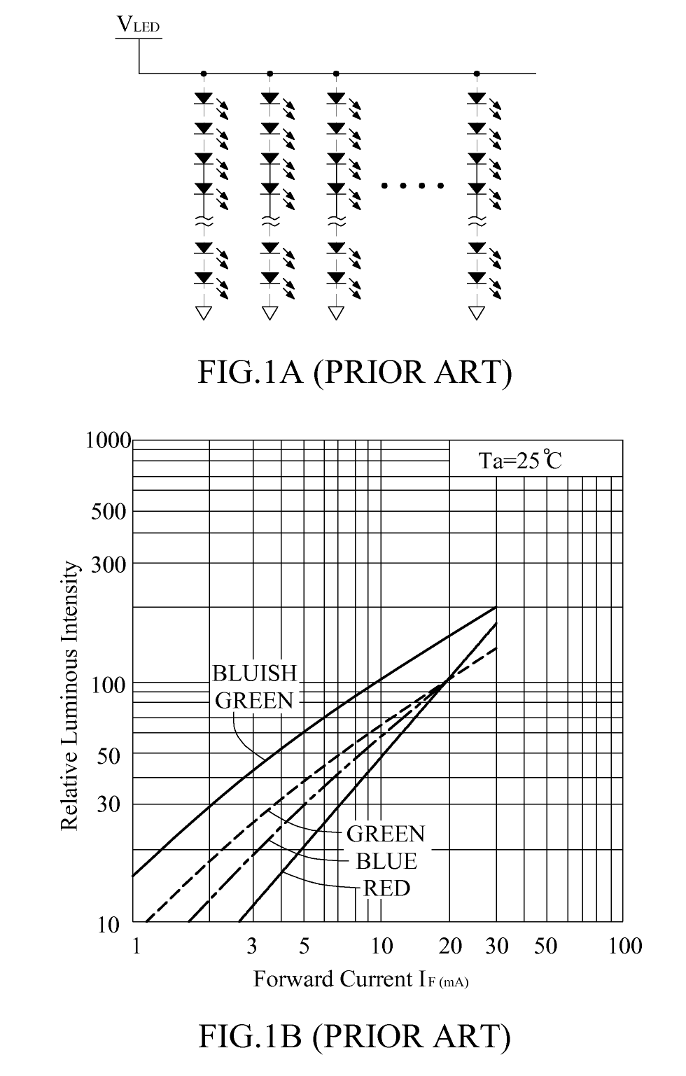

### DETAILED DESCRIPTION OF THE INVENTION

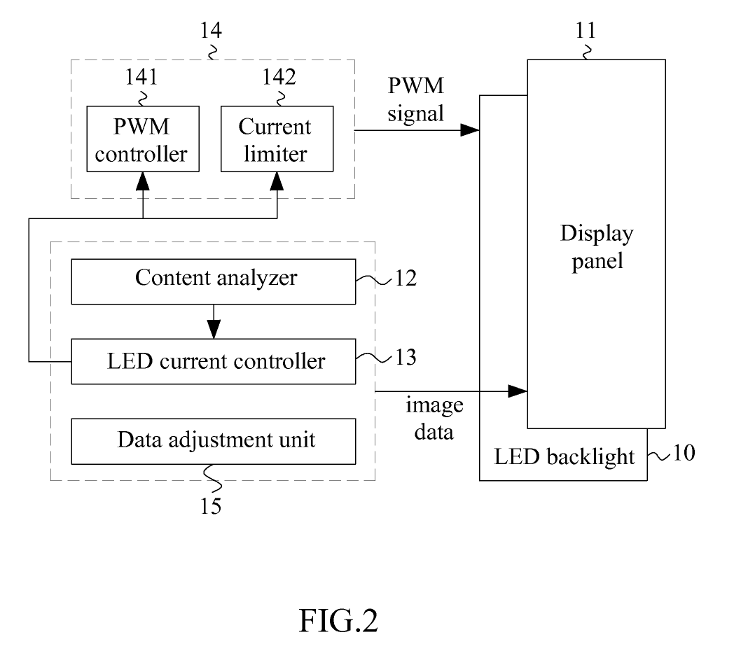

FIG. 2 shows a block diagram illustrating a system of adaptively controlling a light-emitting diode (LED) backlight 10 according to a first embodiment of the present invention. The system of the embodiment may be adapted to a display panel 11, such as a liquid crystal display (LCD) panel, which is illuminated by the LED backlight 10.

In the embodiment, a content analyzer 12 is configured to analyze characteristics (e.g., luminance) of image data to be displayed on the display panel 11. Based on an analysis result of the content analyzer 12, an LED current controller 13 accordingly controls illumination of the LED backlight 10 via an LED driver (board) 14 that is used to drive the LED backlight 10. Specifically, the LED driver 14 includes a pulse-width-modulation (PWM) controller 141, which determines a duty cycle (of a PWM signal) during which the LEDs of the LED backlight 10 are turned on and thus illuminate the display panel 11. Accordingly, a PWM signal with a larger duty cycle allows more current flowing in the LEDs of the LED backlight 10 and the LED backlight 10 thus generates higher luminous intensity (i.e., brighter). On the other hand, a PWM signal with a smaller duty cycle allows less current flowing in the LEDs of the LED backlight 10 and the LED backlight 10 thus generates lower luminous intensity (i.e., dimmer). The LED driver 14 may further include a current limiter 142 that imposes an upper limit (e.g., via a register) on the current that may be delivered to the LED backlight 10 with the purpose of protecting the LEDS of the LED backlight 10 from overheating.

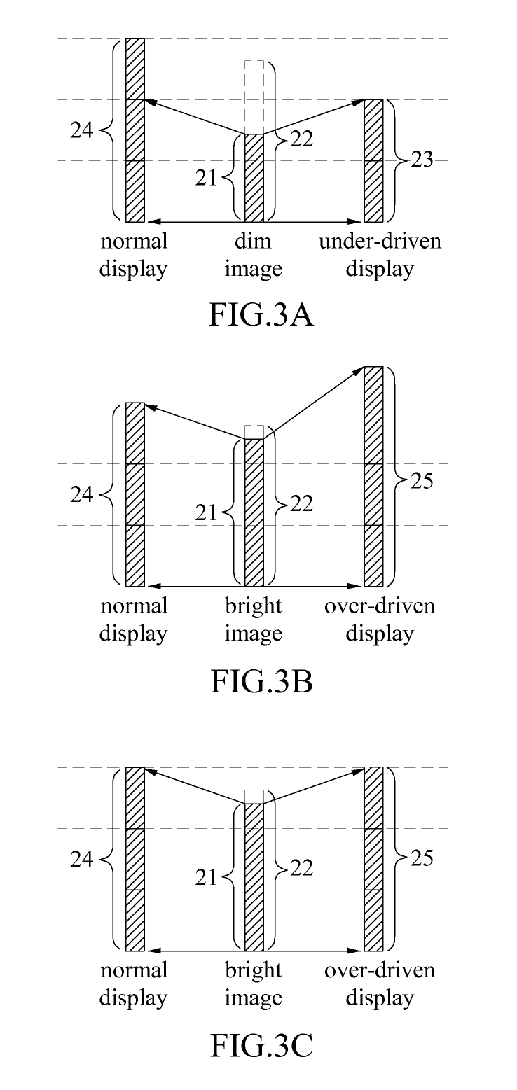

In operation, when the analysis result of the content analyzer 12 indicates that the luminance of the image data is low (i.e., a dim image), the LED current controller 13 controls the PWM controller 141 in a manner such that the current flowing in the LEDs of the LED backlight 10 is below a normal current (e.g., a current recommended by an LED manufacturer). In other words, the LED backlight 10 is under-driven or operates at an under-drive mode. FIG. 3A shows relationship among a normal dynamic range of the display panel 11, a dynamic range of image content and a dynamic range of an under-driven display panel 11. As exemplified in FIG. 3A, the dynamic range 21 of a dim image constitutes only a small portion of a full dynamic range 22. After under-driving the LED backlight 10, the dynamic range 23 of the under-driven display panel 11 is thus substantially lower than the normal dynamic range 24 of the display. Therefore, considerable energy can be saved.

With respect to one aspect of the embodiment, when the analysis result of the content analyzer 12 indicates that the luminance of the image data is high (i.e., a bright image), the LED current controller 13 controls the PWM controller 141 in a manner such that the current flowing in the LEDs of the LED backlight 10 is above a normal current (e.g., the current recommended by an LED manufacturer). In other words, the LED backlight 10 is over-driven or operates at an over-drive mode. FIG. 3B shows relationship among a normal dynamic range of the display panel 11, a dynamic range of image content and a dynamic range of an over-driven display panel 11. As exemplified in FIG. 3B, the dynamic range 21 of a bright image constitutes a substantially large portion of a full dynamic range 22. After over-driving the LED backlight 10, the dynamic range 25 of the over-driven display panel 11 is thus higher than the normal dynamic range 24 of the display. Therefore, a dynamic contrast of the bright image can be increased.

Alternately, as exemplified in FIG. 3C, the over-driving may be achieved by over-driving less amount of LEDs than the example in FIG. 3B. As a result, the dynamic range 25 of the over-driven display panel 11 is approximately the same as the normal dynamic range 24 of the display panel 11. Therefore, cost associated with cutting down the amount of LEDs can thus be reduced.

It is noted that the content analyzer 12 and the LED current controller 13 as discussed above may be implemented in a timing-controller (T-CON) of a video system in hardware, software or their combination. The content analyzer 12 and the LED current controller 13 may, alternately, be implemented in a silicon-on-chip (SOC) processor that typically precedes the timing controller (T-CON) in the video system. The system of the embodiment may further include a data adjustment unit 15 that is utilized to adjust or re-map the dynamic range 21 (FIG. 3A/B/C) of an image to its full dynamic range 22, before the image data are fed to the display panel 11.

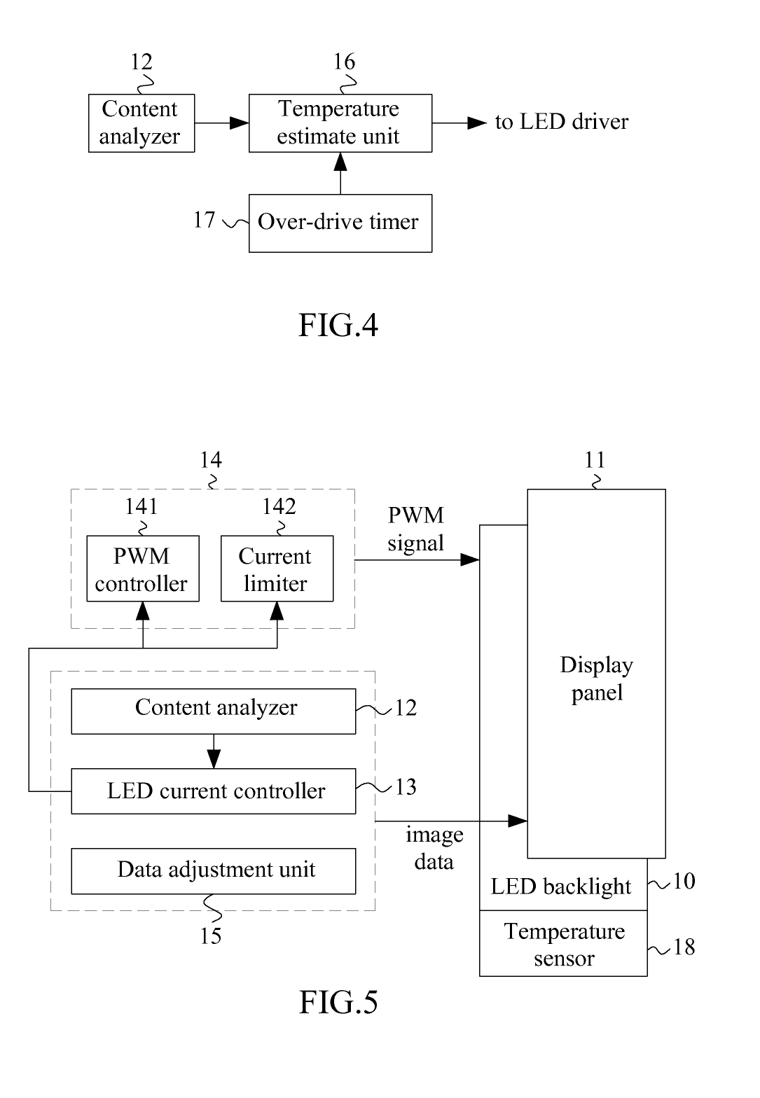

With another aspect of the embodiment, some schemes of protecting LEDs of an over-driven LED backlight 10 from overheating are proposed. FIG. 4 shows a block diagram illustrating a partial system of adaptively controlling an LED backlight 10 according to a second embodiment of the present invention. In the embodiment, a temperature estimate unit 16 is configured to estimate a temperature of an over-driven LED backlight 10, for example, according to the duty cycle of the PWM signal and time lapsed during over-driving as recorded by an over-drive timer 17. When the estimated temperature reaches a high temperature limit, indicating that excessively heat has been generated, the over-drive mode may be temporarily turned off (that is, a normal current is resumed instead), or the over-drive current is temporarily reduced.

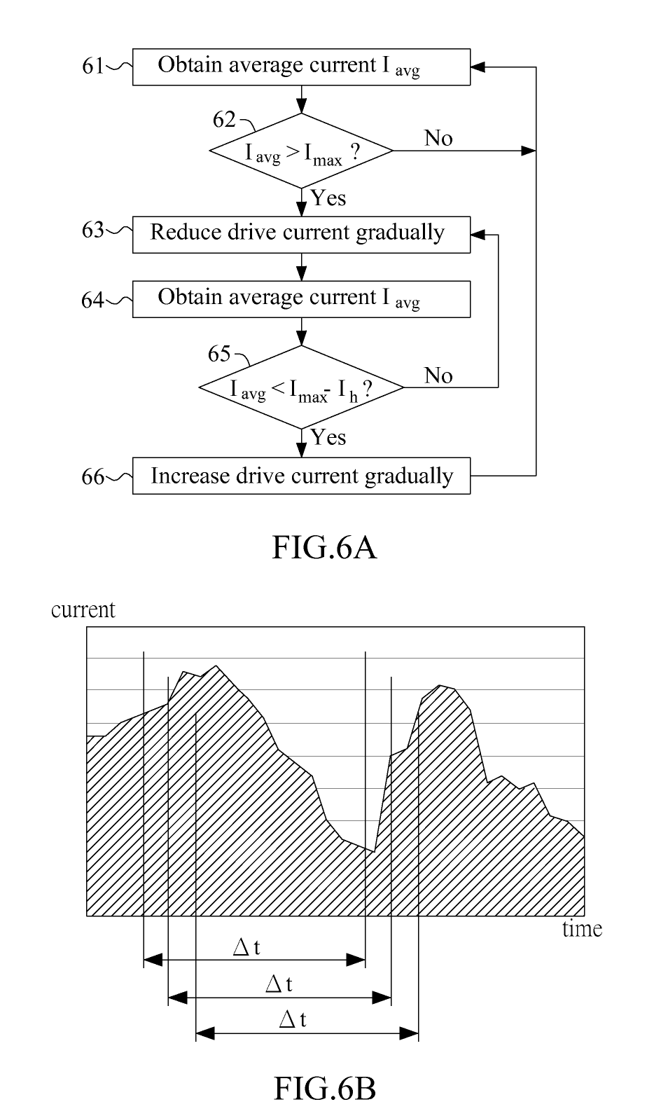

FIG. 5 shows a block diagram illustrating a system of adaptively controlling an LED backlight 10 according to a third embodiment of the present invention. In the embodiment, a temperature sensor 18 is used to detect a temperature of an over-driven LED backlight 10. In case that the detected temperature is higher than a predetermined temperature threshold value, the over-drive current is temporarily reduced, for example, by reducing the duty cycle of the PWM signal.

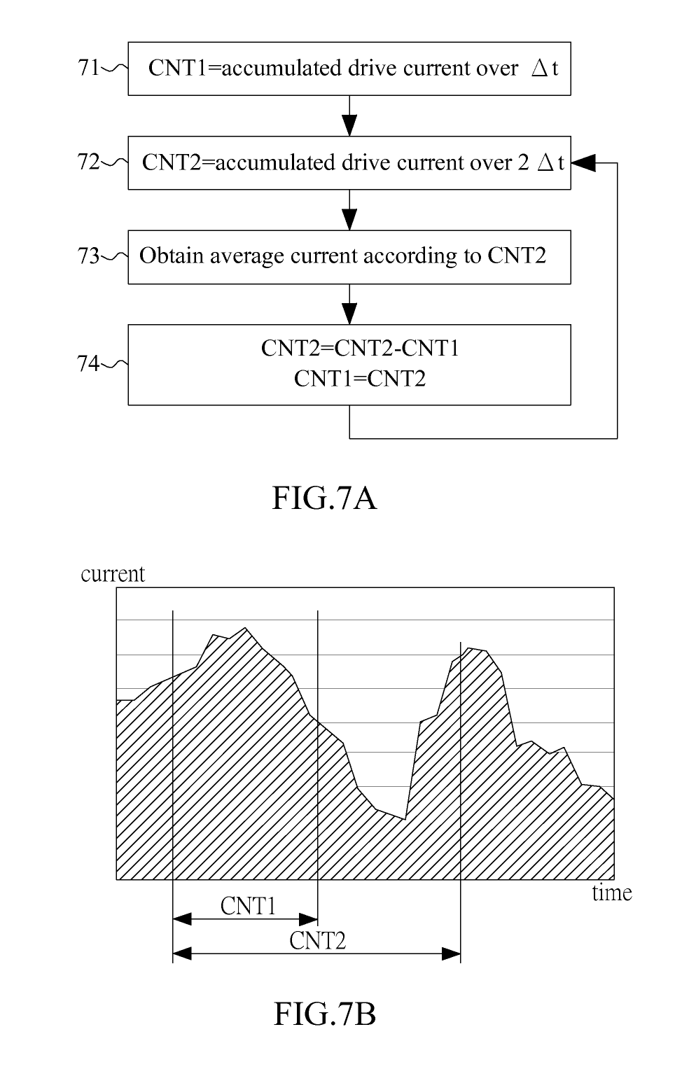

FIG. 6A shows a flow diagram illustrating a method of adaptively controlling an LED backlight 10 according to a fourth embodiment of the present invention, and FIG. 6B shows exemplary drive current variation with respect to time. Specifically, in step 61, drive current values are accumulated over a period Δ t, and then an average current value I_{avg} is obtained, for example, dividing the accumulated current value by Δ t. In practice, the duty cycle of the PWM signal may be processed instead of the drive current for the reason that the drive current is typically in proportion to the duty cycle of the PWM signal. In step 62, the average current value I_{avg} is then compared with an upper limit Iₘₐₓ. If the average current value I_{avg} is not greater than the upper limit Iₘₐₓ, indicating that the LED backlight 10 is safe from overheating, the flow goes back to step 61 to accumulate drive current values and obtain another average current value I_{avg} over a succeeding period Δ t that is shifted slightly, in time, from the preceding period Δ t. If the average current value I_{avg} is determined, in step 62, to be greater than the upper limit Iₘₐₓ, the flow goes to step 63, in which the drive current is reduced to prevent the LED backlight 10 from overheating. Especially, step 63 proceeds gradually or step by step such that a viewer will not perceive an abrupt change in a displayed image. Subsequently, step 64 is performed, similar to step 61, to accumulate drive current values and obtain an average current value I_{avg} over a succeeding period Δ t. In step 65, the average current value I_{avg} is then compared with an upper limit Iₘₐₓ minus a hysteretic value Iₕ. If the average current value I_{avg} is not less than the upper limit minus the hysteretic value (i.e., Iₘₐₓ-Iₕ), indicating that the drive current has not been reduced enough, the flow goes back to perform steps 63 and 64 repeatedly until the average current value I_{avg} is less than the upper limit minus the hysteretic value (i.e., I_{avg}<Iₘₐₓ-Iₕ), at that time, the flow proceeds to step 66, in which the drive current is increased to enhance the dynamic contrast of a bright image. Especially, step 66 proceeds gradually or step by step such that a viewer will not perceive an abrupt change in a displayed image. After completing step 66, the flow goes back to the beginning, i.e., step 61.

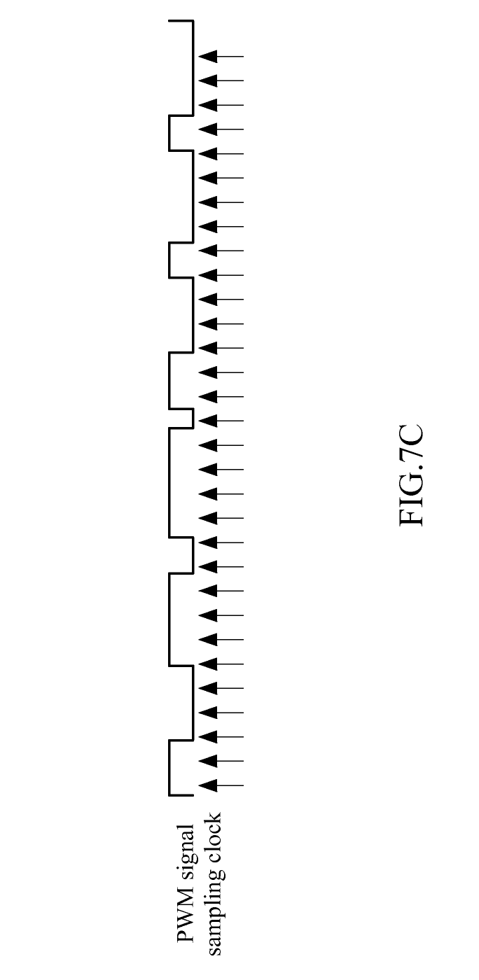

As the accumulation of the drive current values requires a buffer or memory to store the drive current values over a period Δ t, and the acquisition and comparison of the average drive current need computation capability, the fourth embodiment (FIG. 6A/B) as discussed above may preferably be implemented in the timing-controller (T-CON) or the silicon-on-chip (SOC) processor because of their available computation and memory sources. FIG. 7A shows a flow diagram illustrating a method of adaptively controlling an LED backlight 10 according to a fifth embodiment (that does not need a buffer for storing the drive current values) of the present invention, which may be adequately implemented in the LED driver (board) 14, which is typically lacking of sufficient computation and memory sources. FIG. 7B shows exemplary drive current variation with respect to time.

Specifically, in step 71, a first counter (or variable) CNT1 is used to enumerate or count a first accumulated drive current over a (small) unit period Δ t, and, in step 72, a second counter (or variable) CNT2 is used to enumerate or count a second accumulated drive current over a twofold period 2Δ t. The first half of the twofold period 2Δ t coincides with the unit period Δ t. In step 73, an average drive current is obtained according to the second accumulated drive current CNT2, for example, dividing CNT2 by the twofold period 2Δ t. Subsequently, in step 74, the difference between CNT2 and CNT1 is obtained and used as a new (or updated) CNT1. The flow goes back to step 72, in which a new (or updated) second accumulated drive current CNT2 is obtained over a new twofold period 2Δ t. The first half of the new twofold period coincides with the second half of the old (or original) twofold period. In the embodiment, the duty cycle of the PWM signal may be processed instead of the drive current. As shown in FIG. 7C, the duty cycle of the PWM signal may be derived, for example, by sampling the PWM signal by a sampling clock with a frequency higher than that of the PWM signal.

Although specific embodiments have been illustrated and described, it will be appreciated by those skilled in the art that various modifications may be made without departing from the scope of the present invention, which is intended to be limited solely by the appended claims.

What is claimed is:

1. A system of adaptively controlling a light-emitting diode (LED) backlight, comprising:
a content analyzer configured to analyze luminance of image data to be displayed on a display panel;
an LED driver configured to drive the LED backlight; and
an LED current controller configured to control illumination of the LED backlight via the LED driver according to an analysis result of the content analyzer;
wherein the LED current controller over-drives the LED backlight such that a drive current flowing in the LED backlight is above a normal current, when the analysis result of the content analyzer indicates that the luminance of image data is above a predetermined value.

2. The system of claim 1, further comprising a current limiter configured to impose an upper limit on the drive current to be delivered to the LED backlight.

3. The system of claim 1, wherein the LED driver comprises a pulse-width-modulation (PWM) controller configured to determine a duty cycle of a PWM signal that is coupled to control the drive current flowing in the LED backlight.

4. The system of claim 3, wherein the LED current controller under-drives the LED backlight such that the drive current flowing in the LED backlight is below the normal current, when the analysis result of the content analyzer indicates that the luminance of image data is below a predetermined value.

5. The system of claim 3, further comprising:
an over-drive timer configured to record time lapsed during over-driving the LED backlight; and
a temperature estimate unit configured to estimate a temperature of the over-driven LED backlight according to the duty cycle of the PWM signal and the lapsed time recorded by the over-drive timer;
wherein the drive current is reduced when the estimated temperature reaches a high temperature limit.

6. The system of claim 1, further comprising a temperature sensor utilized to detect a temperature of the over-driven LED backlight, wherein the drive current is reduced when the detected temperature is higher than a predetermined temperature threshold value.

7. The system of claim 1, further comprising a processor that performs the following steps:
accumulating drive current values over a period, thereby resulting in an accumulated drive current value;
obtaining an average current value according to the accumulated drive current value and the period; and
reducing the drive current when the average current value is greater than an upper limit;
wherein the step of reducing the drive current is repeatedly performed until the average current value is less than the upper limit minus a hysteretic value.

8. The system of claim 1, further comprising a processor that performs the following steps:
using a first counter to count, thereby resulting in a first accumulated drive current over a unit period;
using a second counter to count, thereby resulting in a second accumulated drive current over a twofold period, a first half of the twofold period coinciding with the unit period;
obtaining an average drive current according to the second accumulated drive current and the twofold period;
obtaining a difference between the second accumulated drive current and the first accumulated drive current, the obtained difference being used as a new first accumulated drive current; and
repeating the step of using the second counter to count, thereby obtaining a new second accumulated drive current over a new twofold period, a first half of the new twofold period coinciding with a second half of the original twofold period.

9. A method of adaptively controlling a light-emitting diode (LED) backlight, comprising:
analyzing luminance of image data to be displayed on a display panel, thereby resulting in an analysis result; and
driving the LED backlight by controlling illumination of the LED backlight according to the analysis result;
wherein the LED backlight is over-driven such that a drive current flowing in the LED backlight is above a normal current, when the analysis result indicates that the luminance of image data is above a predetermined value.

10. The method of claim 9, further comprising a step of imposing an upper limit on the drive current to be delivered to the LED backlight.

11. The method of claim 9, wherein the drive current flowing in the LED backlight is controlled by a duty cycle of a pulse-width-modulation (PWM) signal.

12. The method of claim 11, wherein the LED backlight is under-driven such that the drive current flowing in the LED backlight is below the normal current, when the analysis result indicates that the luminance of image data is below a predetermined value.

13. The method of claim 11, further comprising:
recording time lapsed during over-driving the LED backlight; and
estimating a temperature of the over-driven LED backlight according to the duty cycle of the PWM signal and the recorded lapsed time;
wherein the drive current is reduced when the estimated temperature reaches a high temperature limit.

14. The method of claim 9, further comprising a step of detecting a temperature of the over-driven LED backlight, wherein the drive current is reduced when the detected temperature is higher than a predetermined temperature threshold value.

15. The method of claim 9, further comprising:
using a processor to perform the following steps:
accumulating drive current values over a period, thereby resulting in an accumulated drive current value;
obtaining an average current value according to the accumulated drive current value and the period; and
reducing the drive current when the average current value is greater than an upper limit;
wherein the step of reducing the drive current is repeatedly performed until the average current value is less than the upper limit minus a hysteretic value.

16. The method of claim 9, further comprising:
using a processor to perform the following steps:
using a first counter to count, thereby resulting in a first accumulated drive current over a unit period;
using a second counter to count, thereby resulting in a second accumulated drive current over a twofold period, a first half of the twofold period coinciding with the unit period;
obtaining an average drive current according to the second accumulated drive current and the twofold period;
obtaining a difference between the second accumulated drive current and the first accumulated drive current, the obtained difference being used as a new first accumulated drive current; and
repeating the step of using the second counter to count, thereby obtaining a new second accumulated drive current over a new twofold period, a first half of the new twofold period coinciding with a second half of the original twofold period.
